(19) United States
(12) Patent Application Publication
(10) Pub. No.: US 2025/0346436 A1
(43) Pub. Date: Nov. 13, 2025

(54) BELT CONVEYOR

(71) Applicant: Belanger, Inc., Livonia, MI (US)

(72) Inventors: Barry Stephen Turner, Novi, MI (US); David Louis Tognetti, Howell, MI (US); Jonathan Borlee, Green Bay, WI (US); Kimmo Antero Ukkola, De Pere, WI (US); Rodney James Peer, Green Bay, WI (US)

(21) Appl. No.: 19/200,763

(22) Filed: May 7, 2025

Related U.S. Application Data
(60) Provisional application No. 63/644,050, filed on May 8, 2024.

(51) Int. Cl. B65G 45/22; B60S 3/00; B65G 17/08; B65G 17/46; B65G 23/06; B65G 39/12; B65G 45/02; B65G 45/26

(52) U.S. Cl. CPC B65G 45/22; B65G 17/08; B65G 23/06; B65G 39/12; B65G 45/02; B65G 45/26; B60S 3/004; B65G 17/46

(57) ABSTRACT

A vehicle treatment system supports a continuous belt via a support system including an upper frame, grates disposed on the upper frame, and support plates disposed on the grates. The upper section of the belt travels along the support plates, with water and debris from the upper section passing through the gaps between adjacent plates. Collector trays are disposed below the gaps and above the lower section of the belt to collect water and debris that falls through the gaps. A rinsing manifold below one or more of the gaps projects rinsing fluid upwardly onto the underside of the upper section of the belt. Return rollers are disposed below the lower section of the belt, and are attached and removable from the frame structure without the use of tools. The upper frame may be galvanized, and may include separate attached stainless steel leg portions that are weldable.

### CROSS-REFERENCE TO RELATED APPLICATIONS

This application claims the benefit of U.S. Provisional Patent Application No. 63/644,050, filed May 8, 2024, the entire content of which is hereby incorporated by reference in its entirety.

### FIELD

The present disclosure relates to a belt conveyor for a vehicle treatment system. More particularly, the present disclosure relates to a flat-top belt conveyor for a car wash.

### BACKGROUND

Vehicle treatment systems, such as an automated car wash or the like, utilize a variety of vehicle treatment components and control systems to clean and/or treat the vehicle.

One type of vehicle treatment system is a conveyor system, in which a vehicle enters a vehicle treatment area, such as the interior of a building, where the user drives the vehicle into an entryway of the system and onto a conveyor. The driver then typically places the car in neutral and the conveyor system engages and pushes or pulls the vehicle through the vehicle treatment area. Additional vehicles may also be conveyed before or after the subject vehicle.

As the vehicle is conveyed through the system, various vehicle treatment devices are controllably activated to clean and treat the vehicle, including washing, rinsing, drying, and the like.

One type of conveyor is known as an over/under conveyor, which uses rollers that travel over the top of the looped conveyor member and push behind the wheels of the vehicle, and after reaching the end of the conveyor, the rollers then return below the looped conveyor member and back to the beginning of the conveyor. The rollers traveling below the looped conveyor member also act as support bearings to the belt.

Typically, as the vehicle is entering the vehicle treatment area, the driver must be directed to specifically align the wheels of the vehicle into a narrow channel, to ensure that the wheel is positioned in line with the rollers of the conveyor. This process can be difficult to perform for some drivers, and can result in a stressful experience and may discourage some drivers from using this type of car wash system.

Another type of conveyor for a car wash is a flat top conveyor. A flat top conveyor includes a continuous belt defined by a plurality of links, similar to a chain. This belt does not include the rollers described above. Rather, the belt travels along flat plates having channels or apertures that pass through the plate, and then is routed back to the entry point. The links in the belt allow the spent water, including dirt and other contaminants that have been removed from the vehicle surface, to flow through the belt and then through the channels or apertures. To reduce the amount of dirt that accumulates on the returning potion of the belt, an angled debris deflector is positioned along the length of the belt to catch all of the debris that passes through the channels and apertures that are formed in the plates.

The upper surface of the belt is typically in generally the same plane as the surrounding floor sections, which can include grates or the like. It will be appreciated that some variation between adjacent surfaces may still be present. The guide channels for the vehicle wheels are not used. Rather, the belt can be made such that the driver can simply drive onto the two flat tracks without having to attempt to align the wheel. Flat top systems have the further advantage of being able to convey more vehicles and at a faster rate, thereby increasing overall throughput and quality.

However, the use of the wide linked belt, and the weight of the vehicle on the belt, can result in a high degree of friction between the plate and the belt, reducing the lifespan of the system. Additionally, all of the channels and apertures formed in the plates add additional edges that the belt contacts, increasing the wear. The use of the channels and apertures disposed along the length of the plates allows the dirt to pass and reduces the friction from the dirt, but requires the debris deflector to also be positioned along the entire length of the system.

In addition to the difficulties described above, the flat top conveyor system requires a robust support system to support the belt and the weight of the vehicle. The support system must be corrosion resistant due to the wet environment. Stainless steel may be used, but has a high cost. Steel structures can be galvanized to provide corrosion resistance, but galvanized steel is difficult to weld in a safe manner. Anchoring the support system within the trench formed in the concrete floor can also be difficult. In one approach, lag bolts are secured directly into the concrete or into brackets that are bolted to the concrete. However, this connection to the concrete can be unreliable in some instances, such as in the floor of the trench where water can accumulate. Accordingly, such attachments are usually made into the walls of the trench, which can also be difficult and results in support beams extending fully between the walls of the trench.

Accordingly, improvements can be made to belt conveyor systems, and flat top systems in particular, to reduce friction while also allowing dirt and water to pass through the system in a manner that protects the belt from damage over time. Improvements can likewise be made to the support system installed in the trench of such a system.

### SUMMARY

In one aspect, a vehicle treatment system includes: a continuous conveyor belt having an upper section and a lower section when installed as a closed loop in the system, wherein the belt is configured to be conveyed through the system such that the upper section conveys a vehicle from an entry end to an exit end of the system; a support system configured to support the conveyor belt, wherein the support system includes: a plurality of support structures in the form of a support plate, wherein the support plate directly contacts and supports the underside of the upper section as it is conveyed from the entry end to the exit end; at least one grate structure disposed below the support plates, wherein the grate structure defines a plurality of open cells extending therethrough, wherein the grate structure supports the underside of the support plates; and a frame structure disposed below the grate structure, wherein the frame structure supports the underside of the grate structure; wherein the support plates are positioned on the grate structure to define a plurality of gaps longitudinally between adjacent ones of support plates, such that water and dirt will pass through the gap and the grate structure during a vehicle wash process.

In one aspect, the support plates do not have any channels or apertures formed therethrough.

In one aspect, each support plate is completely solid between a front edge and rear edge of the support plate along an interface between the support plate and the belt.

In one aspect, the supports plates have a chevron shape with a V-shaped front edge and V-shaped rear recess, wherein the support plates are disposed in series longitudinally and define V-shaped gaps therebetween.

In one aspect, a collector tray is disposed below multiple ones of the gaps defined between adjacent support plates such that multiple collector trays are disposed along the length of the system.

In one aspect, the collector trays are spaced apart along the length of the belt, wherein the collector trays are disposed below the grate structure and above the lower section of the belt.

In one aspect, a rinsing mechanism is disposed below one or more of the gaps defined between adjacent support plates and aligned with the gap, such that an upward rinsing spray passes upwardly through the corresponding gap and into contact with the underside of the upper section of the belt as the belt is conveyed over the gap.

In one aspect, the rinsing mechanism includes a rinse manifold disposed within a manifold tray.

In one aspect, the manifold tray is disposed in a gap defined longitudinally between successive grate structures.

In one aspect, the manifold tray includes a plurality of wall members extending upwardly from a base of the manifold tray, wherein the wall members support the underside of one or more of the support plates.

In one aspect, a rinsing device is positioned laterally adjacent the collector tray and controllable to provide a rinsing spray to the collector tray.

In one aspect, a lubricating device is positioned at an entry end of the system, wherein the lubricating device is a plate having a fluid inlet disposed therein, wherein the fluid inlet is in fluid communication with a recess formed in the plate, wherein the recess matches a profile of a front edge of the support plate disposed adjacent the recess, such that fluid provided from the inlet enters the recess and exits the recess upwardly at the front edge of the support plate and onto the underside of the belt, wherein the belt carries the fluid onto the support plate.

In one aspect, the fluid inlet is covered by the front end of the support plate, such that fluid from the inlet is blocked by the front end and forced into the recess.

In one aspect, the support system includes support rollers disposed below the lower section of the belt and supporting the underside of the lower section of the belt as the belt travels from the exit end to the entry end.

In one aspect, the support rollers are provided on a roller frame, wherein the roller frame has a shape that is received and fixed in a corresponding slot structure without the use of fasteners.

In one aspect, the support rollers are spaced apart longitudinally at non-uniform locations along the length of the belt to reduce harmonic undulations of the lower section of the belt.

In one aspect, a drive system is disposed at the exit end of the system, wherein the drive system includes an output shaft having a plurality of sprockets indexed to links of the belt, such that each side of the system is driven in unison.

In one aspect, one of the belts includes a plurality of projecting tabs that project upwardly from the upper section and engage with one or more vehicle wheels.

In one aspect, the support plates include a plurality of notches formed at lateral edges of the support plates, wherein a side clamp is fixed to the support frame and includes downwardly projecting teeth, wherein the teeth extend into the notches, wherein the side clamp fixes the support plate longitudinally via the teeth projecting into the notches.

In one aspect, the side clamp engages multiple adjacent support plates, such that the gap defined between adjacent support plates is fixed and maintained via predetermined spacing of the teeth and the notches.

In one aspect, the support system includes an upper frame on each lateral side of the system, wherein each upper frame includes a plurality of welded beams, wherein the grate structures are disposed on the upper frame and supported on the upper frame.

In one aspect, the upper frame is galvanized steel, wherein the support system includes a plurality of separate leg portions mounted to the upper frame, wherein the leg portions are stainless steel and attached to the galvanized steel upper frame via fasteners, wherein the stainless steel leg portions are welded to stainless steel floor supports that are fixed to a bottom of the vehicle treatment area.

In one aspect, the upper frame has a rectangular envelope not including the leg portions, wherein the rectangular envelope has a height less than a lateral width of the upper frame, such that the upper frame are stackable and shippable in a welded state before and after galvanizing.

In one aspect, each upper frame includes wall portions disposed on opposite lateral sides of an upper surface of the upper frame, wherein the grate structure is disposed laterally between the wall portions.

In one aspect, each upper frame includes multiple wall portions disposed on each lateral side, wherein longitudinally adjacent wall portions are spaced apart to define a longitudinal opening therebetween such that water may pass laterally outward between the wall portions through the longitudinal opening.

In one aspect, side clamps are disposed on the upper surface of the wall portions, wherein the side clamps are disposed over the support plates that are disposed on the grates and clamp the support plates in place, wherein the side clamps further have a recessed surface relative to a top surface of the side clamp, the recessed surface configured to support a further grate.

In one aspect, the side clamps include laterally inner side clamps on the laterally inner sides of each of the upper frames and laterally outer clamps on the laterally outer sides of the upper frames, wherein the further grate is a center grate disposed laterally between the laterally inner side clamps or the further grate is a side grate disposed laterally outward from the laterally outer side clamps.

In one aspect, the support system further includes entry and exit sections, wherein the exit section supports a drive unit and drive shaft that drives the belt, and the entry section supports an idler roller and a lubricating device that lubricates the belt.

It will be appreciated that various aspects described above may be combined, and that not all aspects described together are required.

### BRIEF DESCRIPTION OF THE DRAWINGS

In the drawings:

FIG. 1 is a perspective view of a vehicle treatment system in the form of a flat top belt conveyor;

FIG. 2 is an exploded view of a middle section of the system, including a plurality of support plates supported on grate structures and a frame structure, and including collector trays and a manifold tray disposed below gaps defined between adjacent support plates;

FIG. 3 is a partial exploded view of the middle section;

FIG. 4 is an exploded view of an entry end of the system including an idler roller;

FIG. 5 is an exploded view of an exit end of the system including a drive unit;

FIG. 6 is perspective view of the collector tray;

FIG. 7 is a perspective view of the manifold trays and rinsing manifolds, along with the collector trays;

FIG. 8 is a perspective view of the manifold tray;

FIGS. 9A and 9B are perspective views of the rinsing manifold and an associated valve;

FIG. 9C is a top view of the rinsing manifold disposed in the manifold tray below the gap between adjacent support plates;

FIG. 10 is a perspective view of a transition plate and a lubricating inlet and recess;

FIGS. 11A is a perspective view of a return roller assembly including rollers and a mounting plate, which is configured for tool-less installation and removal relative to the frame structure;

FIG. 11B is a side view illustrating the return roller secured in the system in a tool-less installation;

FIG. 12 is a perspective view of a fluid manifold disposed at the entry end for providing fluid to the lubricating inlet and/or the rinsing manifolds;

FIG. 13 is another perspective view of the fluid manifold disposed at the entry end;

FIG. 14 illustrates trunk lines for providing fluid to the rinsing manifolds;

FIG. 15 is front view illustrating a component stackup, including support plates supported on grate structures and a frame structure, and side clamps attached to wall portions of the frame structure, which hold the plates down onto the grate structures;

FIG. 16 is a perspective view illustrating the side clamps and wall portions holding the support plates to the grate structure and maintaining a gap between the plates for water and debris to pass through the gap and grates for collection on an underlying tray;

FIG. 17 is a perspective view of the wall portion to which the side clamps are attached;

FIG. 18 is a perspective view of a first section of the system in an assembled state and configured to cooperate with additional upstream and downstream sections of the system; and

FIG. 19 is a perspective view a second section of the system in an assembled state and configured to cooperate with additional upstream and downstream sections of the system.

### DETAILED DESCRIPTION

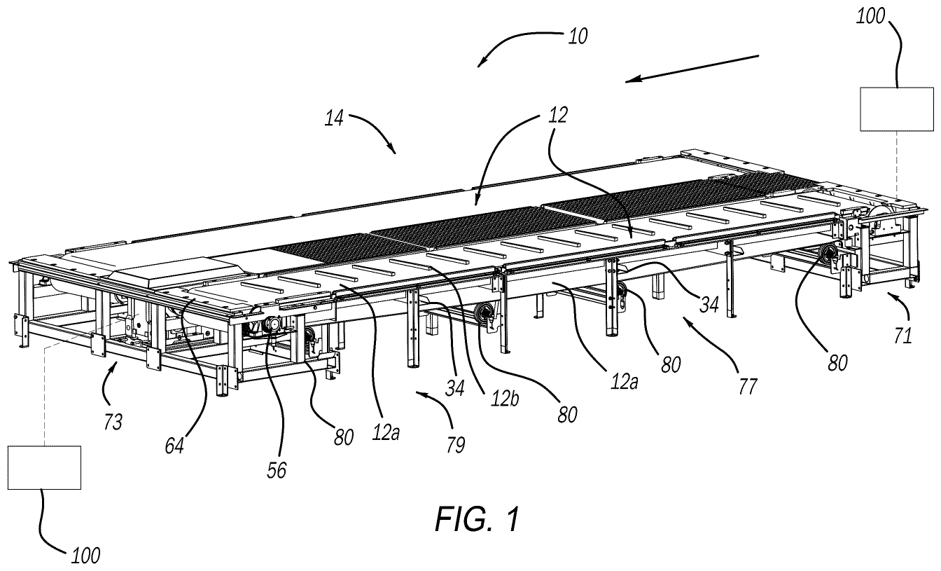

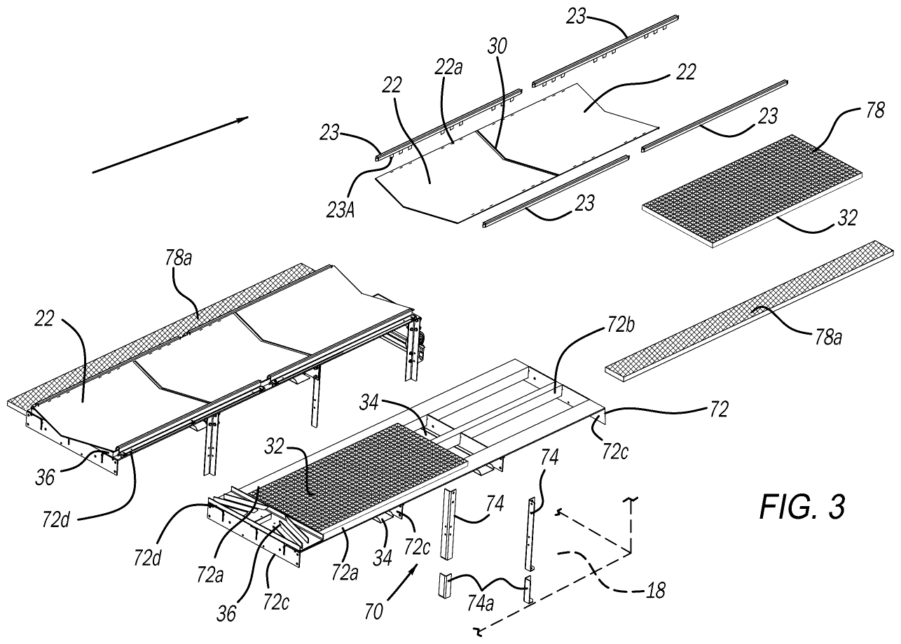

With reference initially to FIG. 1, a vehicle treatment system 10 is shown in a perspective view. The system 10 is in the form of a flat top conveyor system, including a pair of continuous belts 12 that extend from an entry end to an exit end of a vehicle treatment area 14. The belts 12 combine with the surrounding floor area (not shown in FIG. 1) to create a generally consistent flat surface upon which vehicles can easily enter and exit the treatment area 14 and be aligned with the tracks defined by the two belts 12. The belts 12 may be of different types on opposite lateral sides of the system, such that one type of belt 12a (which includes upwardly projecting tabs 12b) may be used on one side. It will be appreciated that the belts 12 on each lateral side of the system may both include the tabs 12b, or that neither belt may include in the tabs 12b. FIG. 1 illustrates a view of the system 10 outside of a trench area 18 (shown schematically in FIG. 3) of a vehicle treatment site, such as a car wash, with the belt surface raised relative to the bottom of the trench 18 on which the system 10 is supported. The system may include a control system or controller 100 (capable of sending and receiving control signals and feedback, and automatically operating and controlling the various components) to controllable drive the belt and/or control the provision of the desired fluids throughout the system 10). The belts 12 are preferably made from a series of interconnected members (as described further below), and for ease of discussion will be referred to as a belt. The use of the term “belt” shall not be limiting with regarding to particular material or style of construction.

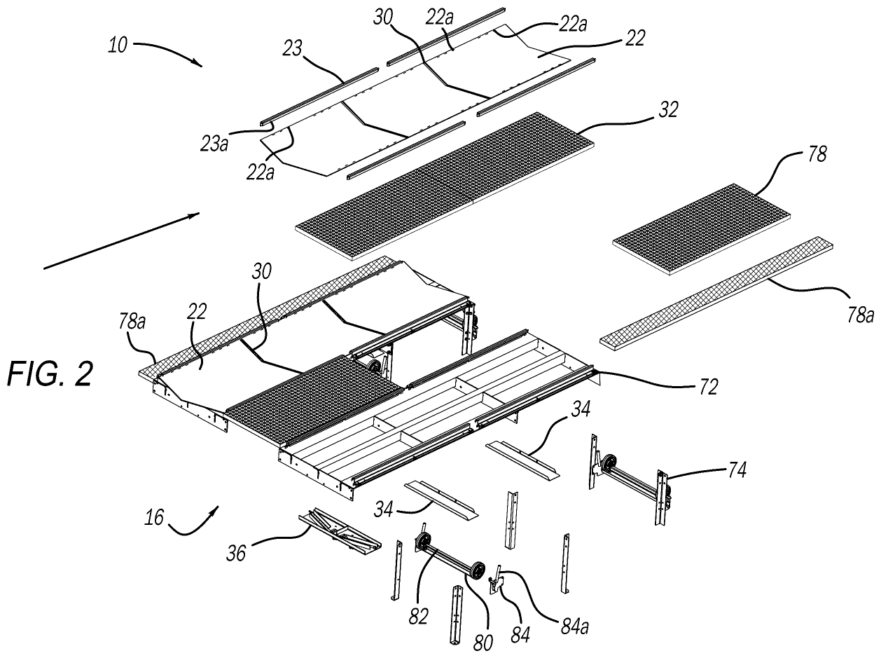

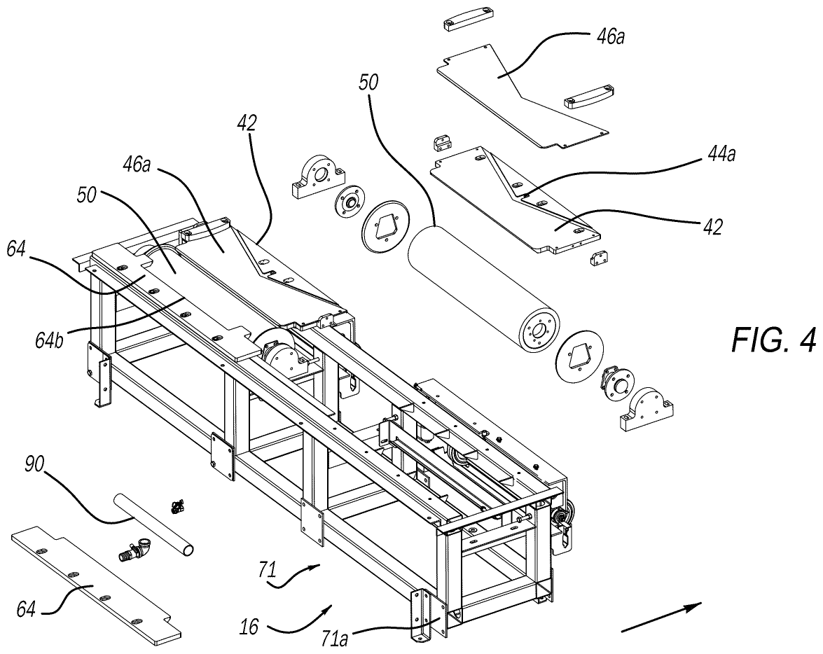

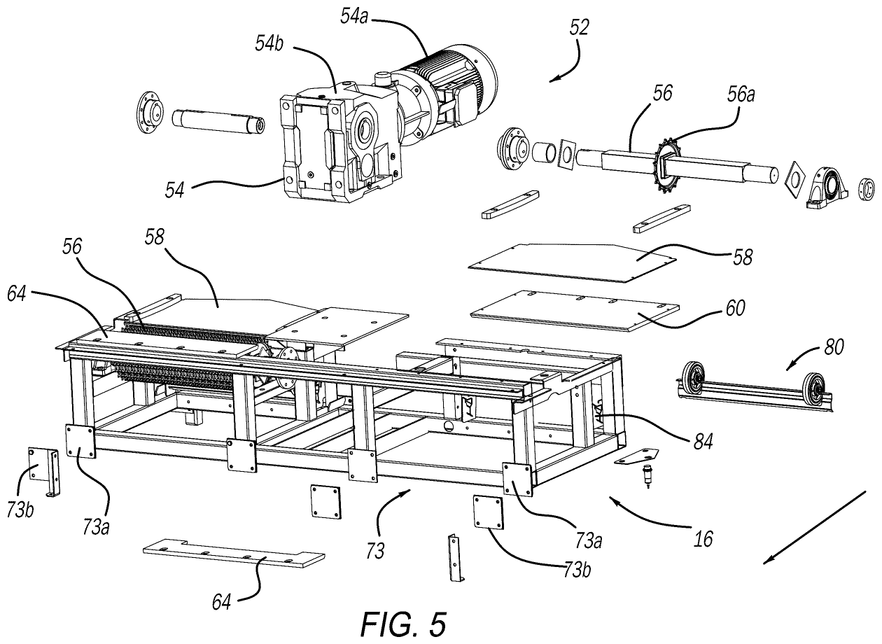

FIGS. 2-5 illustrate various sections of the system 10 in exploded views, including intermediate sections (FIGS. 2 and 3), the entry end (FIG. 4), and the exit end (FIG. 5). The belts 12 are not shown in these views, such that the underlying structures can be more easily viewed. In FIGS. 2-4, vehicles are conveyed from left to right. In the view of FIG. 5 showing the exit end, vehicles are being conveyed from right to left, such that the left side of the system from FIGS. 2-4 is on the right side of FIG. 5.

The belts 12 are supported via a support system 16 illustrated in various Figures, including FIGS. 2-5, described in further detail below, which supports the belt 12 as it moves through the treatment area and conveys the vehicle supported thereon. The belt 12 is formed in a continuous loop, and during use has an upper section that is in contact with the vehicle and which conveys the vehicle, and a lower section that returns from the exit end to the entry end. The support system 16 supports the upper section and further supports the lower section of the belt 12, with the upper and lower sections forming a continuous loop. It will be understood that the actual links and other portions of the belt 12 defining the upper section will eventually become part of the lower section as the belt 12 is conveyed and driven through the system, eventually becoming the upper section again once reaching the entry end being looped back to the top.

The support system 16, as described above, is disposed within trench 18 (shown schematically in FIG. 3) formed in the floor of the vehicle treatment area. The support system 16 may include a variety of structure providing support to various components of the support system 16 itself, as well as various treatment components. As described further below, the support system 16 is configured to be attached to the bottom surface of the trench 18. For instance, the feet of the support structure may attach to the bottom of the trench, such that the walls of the trench 18 are not required to receive any permanent or semi-permanent fixing structure.

The arrangement of the support system 16 and belts 12 will now be described with respect to the support provided to the belts 12 as they are conveyed through the system. For the purposes of discussion, a single belt 12 will be described, but it will be appreciated that reference made to one belt is applicable to the other belt 12 as well, unless otherwise noted or apparent from the description and figures.

The belt 12 is in the form of a series of interconnected links, similar to a chain. The links are preferably an injection molded rigid plastic material, and are configured to pivot relative to each other at their respective connection points to create a closed loop and flexible belt structure. The links may be a combination of a two-piece structure, with a lower portion received within a corresponding cavity of an upper portion. The lower portion and upper portion may be made of different materials, with the upper portion being generally softer and better suited for engagement with a rubber vehicle tire, and the lower portion being generally harder and more resistant to wear and having a lower coefficient of friction. The lower portion that is nested in the upper portion may project downward from the upper portion such that it has a smaller surface area, thereby reducing the area that is in contact with the underlying surface. It will be appreciated that other linked arrangements may be used for the belt structure, such that spent water and other liquid/debris from the vehicle treatment process may pass through the links and be rinsed from the links.

The underside of the belt 12 (such as the combined lower portions or surfaces of the various links that are not in contact with the vehicle tires) is supported on a plurality of upper support members or support plates 22, which may be individually referenced herein. The support plate 22 is generally constructed of stainless steel, thereby being durable and resistant to corrosion. The support plate 22 may have a “chevron” type shape, with one end having a pointed end, and the opposite end having a correspondingly shaped pointed recess, or flared end. In one aspect, the pointed end is the entry end that first contacts the belt, and the flared end is the exit end that the belt 12 passes over after being in contact with a given support plate 22.

The support plates 22 are arranged to be placed in the support system 16 in a longitudinal series, with the pointed ends being received in the pointed recesses or between each side of the flared end. The series of plates 22 are arranged on each side of the system 10, forming two longitudinal tracks along which the belts 12 can be conveyed. The plurality of plates 22 therefore combine to provide support to the belt 12 along the length of the system 10 as the belts 12 travel along the system 10 and convey the vehicle supported thereon.

Due to the pointed end of the support plate 22 being disposed within the recess of the adjacent plate 22, at a given longitudinal position, the belt 12 may be supported by more than one plate, with the receiving plate supporting the belt on opposite lateral sides of the pointed end.

According to an aspect of the disclosure, the plates 22 are solid between respective front and rear edges. The front edge may also be considered the front end, first end, or entry end, which is the end/edge where a given portion of the belt 12 will first make contact with the plate 22. The rear edge may also be considered the rear end, second end, or exit end, and is the end where the given portion or section of the belt 12 will pass after it has been conveyed along the plate 22. The front end of the plate 22 may be the pointed end, and the rear end of the plate 22 may the recessed end.

The plates 22 being solid between the front and rear edges results in a reduced number of edges that make contact with the belt 12. The plates 22 do not include any openings or channels or apertures that extend through the plate for water and debris to pass. Rather, the water and debris will be carried to the end of each respective plate 22.

The support plates 22 are spaced apart longitudinally at a predefined distance to define a gap 30 between the front and rear edges of adjacent plates 22. The water and debris can therefore be collected below this gap 30. The gap 30 has a bent or angled shape, corresponding to the bent or angled profile pointed end of the plate 22 that is received in the adjacent pointed recess. In one aspect, the bent shape of the gap 30 is symmetrical, with the apex of the gap being disposed at the centerline of the plates 22.

In another aspect, the bend or angle of the pointed end and corresponding recess of the plate 22 may be asymmetrical, with the apex being offset from center. In other aspect, the angle on one side of the apex may be different than the angle on the opposite side of the apex. In another aspect, the plate may have a parallelogram shape or trapezoid shape. In another aspect, the plate may have multiple bends or apexes, similar to multiple teeth. In each case, a generally consistent gap may be defined between adjacent plates, with the exit end of the plate having a shape or profile that matches the entry end of the adjacent plate. Generally, each of the plates may have the same shape and overall length, however in some cases due to the overall length of the system, one or more shorter plates may be provided to complete the overall length.

The front edge of the plate 22 can be tapered or beveled such that the front edge that makes contact with the belt 12 is smooth, thereby reducing wear. The rear edge can similarly be formed to have a smooth edge. The size of the gap 30 is selected so as to allow a desired amount of water and debris to pass through the gap 30 as it is conveyed along with the belt 12. As further discussed below, the spent water and debris is collected in the area below the gap 30 after the water and debris being carried along with the belt has passed over the rear edge, with the water and debris passing through the gap 30 due to gravity and/or other rinsing.

As described, the plates 22 themselves do not define or include any channels, openings, or apertures passing through the plate body. The lack of channels or apertures formed in the body of the plates 22 further provides an extended smooth surface, without any additional edges between the front and rear ends. Accordingly, the friction encountered by the edges of such channels or apertures is also reduced. The bent or angled shape of the gap 30 further reduces the friction at any given longitudinal location of the belt 12 as it passes, relative to a gap that extends perpendicular to the belt that would cause the entire width of the belt to encounter the gap 30 at the same time. Thus, in a lateral direction, the belt 12 is always substantially supported by the combination of the two adjacent plates 22 as the belt is passing over the gap 30, as opposed to a laterally extending gap that would result in a sections where the belt has no support.

The plates 22 are preferably installed in the support structure 16 in a fixed position, such that the gap 30 is maintained and fixed against longitudinal migration due to friction as the belt 12 is pulled or pushed across the plates 22. In one aspect, the plates 22 may include notches 22a at the outer lateral edges, which receive projections or teeth 23a that are disposed on the underside of clamps 23 (discussed in further detail below) of the support system 16. In another aspect, a spacer member may be disposed in the gap 30 longitudinally between the adjacent plates 22. For instance, a spacer may be placed at the apex of the gap 30. By fixing the plates 22 to the clamps 23, and the clamps 23 to the support system 16, the plates 22 are accordingly fixed in place relative to the support system 16.

In addition to the benefit and use of the gap 30 allowing water and debris to flow downwardly and to be collected below the gap 30 at a predetermined and distinct location, the gap 30 also provides access for a rinsing system to project water or other fluid upwardly into contact with the underside of the belt 12 as the belt passes over and along the plates 22 and over the gap 30, which will be described in further detail below.

Turning now to the components below the support plates 22, the support system 16 may further include one or more grate structures 32, which may also be referred to as grates 32. The grates 32 may have a generally rectangular shape, and may be disposed directly below the support plates 22 at locations along the length of the system 10. The number of grates 32, like the number of plates 22, may depend on the overall length of the system 10. While the grates 32 may extend along a majority of the length of the system 10 for supporting the support plates 22, other structures may be disposed along with the grates to provide direct support below the plates 22. Put another way, at various locations along the length of the system 10, adjacent grates 32 may be spaced from each other, with the space occupied by another support component (such as a rinsing or fluid providing manifold tray, further described below). The overall length of the system will determine the number of grates 32, and the grates 32 may also be provided at different lengths to allow for a tailored overall length.

The grates 32 may be in the form of fiberglass grating, defining a plurality of square/rectangular cells. The fiberglass material of the grates 32 does not directly contact the moving belt, and therefore need not be as durable against frictional wear as the plates 22, which are the components that make the direct contact with the underside of the moving belt 12. The use of the grating with the plurality of cells permits water and debris to pass from the gaps 30 and then downwardly through the grates 32 due to gravity. Due to the grid-like grate pattern, there are various small areas (corresponding to the thickness of the cell-defining walls) below the gap 30 that are blocked, but with the cells being below the upper surface of the plates 22, water and dirt falling over the edge of the plates 22 and through the gaps 30 may shift laterally, and also pass through the cells of the grate 32, so that the structure of the grates 32 defining the cells does not adversely affect the water and debris being moved downwardly. In the areas/cells of the grate 32 that are completely covered by the plate 22, meaning the regions effectively extending from the rear-most point of the front edge to the front-most of the rear edge, water and dirt will generally not pass into the cells at all. Accordingly, the majority of the length of the system does not have water and debris falling down from and through the belt 12 and the grates 32. In this way, predetermined and distinct longitudinal locations of the system can be identified and monitoring for the passing of debris and water, which can be addressed and controlled as described below.

In one aspect, each side of the support system 16 may be arranged generally symmetrical, with corresponding gaps 30 and plates 22 and both the left and right sides along the length of the system. Thus, the locations at which debris will pass may also be the same on each lateral side of the system and for each of the left side and right side belts 12.

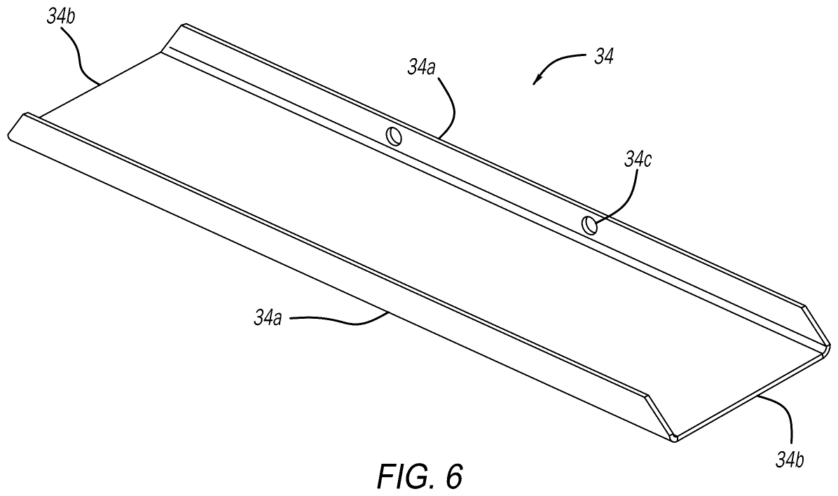

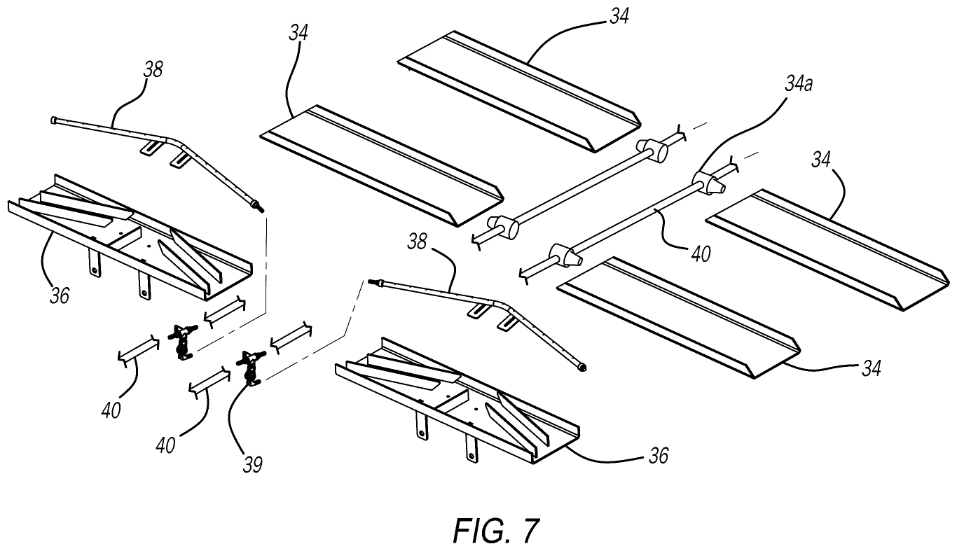

With reference to FIG. 2, as well as FIGS. 6 and 7, in one or more predetermined areas corresponding to the gaps 30, in order to capture the water and debris that passes through the cells of the grates 32 from the gaps 30, the support system 16 may include one or more collector trays 34. The collector tray 34 has a lateral width that generally corresponds to the lateral width of the gap 30 and the plates 22, and a length that generally corresponds to the longitudinal extent of the bent shape of the gap 30 that is defined by the point of the chevron shape of the plate 22. The collector trays 34 can therefore be disposed at distinct locations along the length of the system 10 as desired, below select gaps 30, to collect the water and debris from below the gaps 30 and grates 32. The collector trays 34 may therefore also be described as debris trays.

In one aspect, the collector tray 34 is formed of bent stainless steel sheet metal, with upstanding walls at the front and rear walls 34a, with the lateral sides 34b of the collector tray 34 being open (See FIGS. 6 and 7). However, in another aspect, the trays 34 may be made from fiberglass or the like, or other non-corrosive material. The open sides of the trays 34 allow for the trays 34 to be rinsed from the sides for cleaning or dispersing the water and debris that has accumulated (for instance via rinsing device 34a controllably connected to a water supply such as trunk line 40 or another water/fluid supply line, and with a manually or electrically controllable valve 39, similar to the provision of water/fluid to manifold 38 described below), with the front and rear walls otherwise containing the water and debris in the fore-and-aft direction. Similarly, water or debris from the tray 34 can naturally pass over the lateral edges without being actively sprayed due to the continued flow of water and debris into the constrained space defined by the front and rear walls.

In one aspect, the tray 34 is laterally wide enough such that the lateral sides are outboard relative to the lower section and the returning portion of the belt 12 that passes below the trays 34. Thus, water and debris falling over the lateral edge of the trays 34 will generally not fall onto the belt 12 in these distinct drainage sections that correspond to the various distinct gaps 30. Thus, there is generally no overlap or clear path for water and debris passing through the belt 12, the gap 30, and the grates 32 to fall directly onto the lower returning section of the belt 12.

Water and debris in the middle of the tray 34 will generally not pass onto the belt 12 from the middle section due to the front and rear walls of the tray 34. The trays 34 are fixed to another rigid structure of the support system 16, and remain fixed in place. In one aspect, the trays 34 are mounted so as to be horizontal. The trays 34 may also be angle adjustable (via oversized or elongate mounting slots 34c formed in the tray) to assist in rinsing the water and debris collected in the tray 34. In one aspect, the trays 34 may have an associated rinsing nozzle at one or more of the lateral sides of the tray 34, which may be controlled to spray a rinsing fluid laterally across the tray to rinse off the water and debris that is collected in the tray 34.

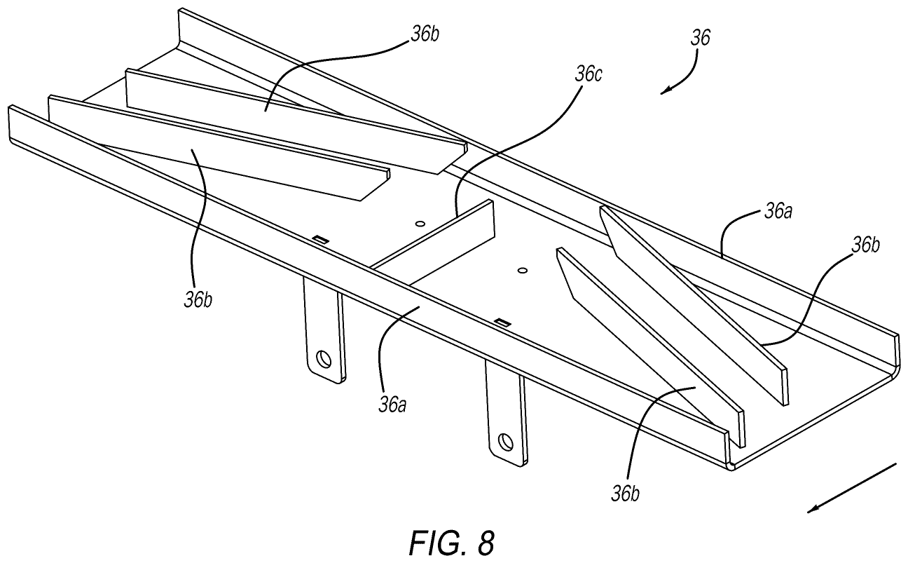

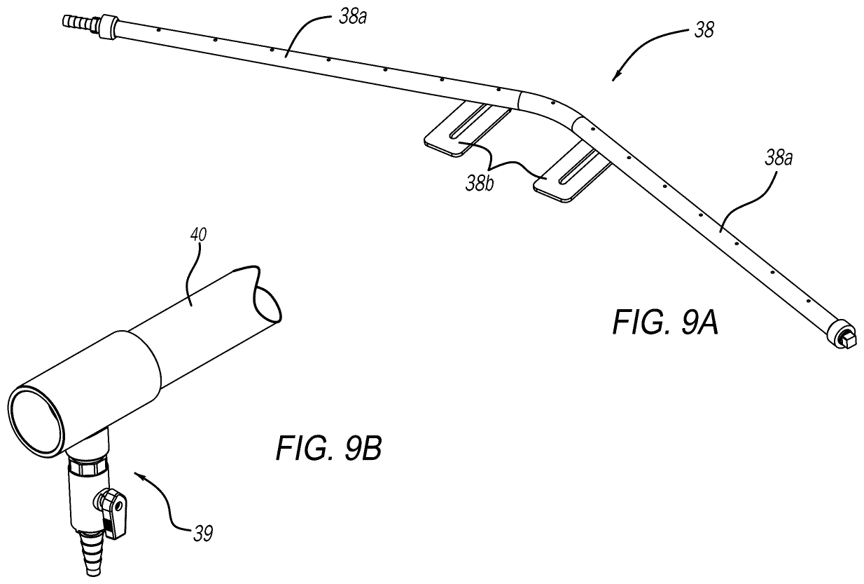

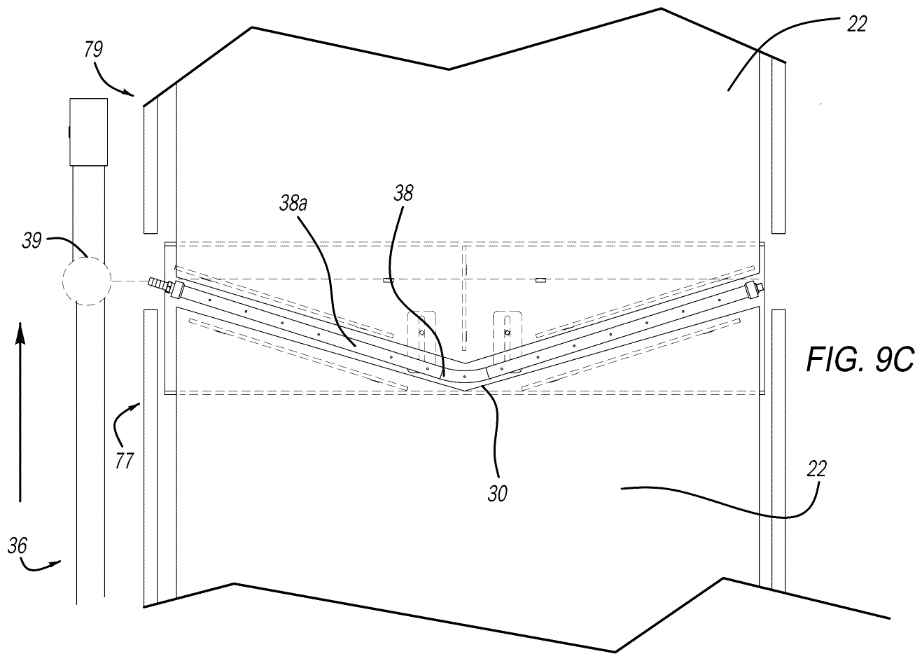

As described above, in addition to the gaps 30 permitting drainage, the gaps 30 may also be used to provide access for upwardly directed rinsing or other provision of fluid toward the upper conveying section of the belt 12 that passes along the plates 22 and over the gaps 30. Accordingly, with reference to FIGS. 2, 7, and 8, at select gaps 30, rather than have a portion of the one of the grates 32 under the ends of the plates, the support system 16 may instead have a manifold tray 36 disposed under the edges of the plates 22 and under the gap 30. The manifold tray 36 may be provided to support a rinsing manifold 38 (FIG. 9A) and may be used as an insert disposed longitudinally between adjacent grate structures 32. Thus, the manifold tray 36 and the grates 32 may combined to provide support to the plates 22. In the location of the manifold tray 36, the gaps 30 can accordingly not include a collector tray below, because the manifold tray will generally block water and debris from directly falling onto the lower returning section of the belt 12 at this location.

The manifold tray 36 may be made of stainless steel, and may include upstanding walls 36a at the front and rear ends, similar to the collector tray 34. Unlike the collector tray 34, the manifold tray 36 is not disposed below the grate 32. Unlike the collector tray 34, the manifold tray may provide direct support to the plates 22.

The manifold tray 36 may have a generally rectangular shape, facilitating ease of installation between the grates 32. Due to the chevron shape of the plates 22, the manifold tray 36 may include internal walls 36b that provide support to the plates 22, and that may correspond to the angle of the front and rear edges of the plates 22. For instance, to correspond to the pointed and bent profile of the front and rear edges, a V-shaped arrangement of the internal walls 36b may be provided. Accordingly, the front edge of the plate 22 that overhangs the manifold tray 36 may be supported along a majority of its length by the corresponding internal wall 36b of the manifold tray 36. Similarly, the rear edge of the adjacent plate 22 upstream of the manifold tray 36 may also be supported by internal wall sections 36b. A further wall section 36c may extend in a longitudinal direction and be disposed along the centerline and below the plate 22 to support the center of the pointed front end of the downstream plate 22. In one aspect, the central wall section 36c may provide the support to the pointed end without the angled wall sections.

In addition to supporting the plates 22 above, the manifold tray 36 also supports the rinsing manifold 38 (FIGS. 7 and 9). The manifold 38 may also be used to provide various other types of fluids for different purposes, not just for rinsing. For purposes of discussion, rinsing with water will be described, which can also be referred to as flushing.

The manifold 38 is in the form of a tube having a bent shape that corresponds to the shape of the gap 30, such as a V-shape. It will be appreciated that for other gap profiles, the manifold 38 may have a corresponding profile. The manifold 38 is fixedly mounted to the manifold tray 36 in the space between the internal walls 36b. The manifold 38 has a controllable inlet that receives water from a water source. In one aspect, the manifold 38 is connected to a longitudinally extending trunk line 40 on each lateral side of the system. The trunk line 40 may be provided with pressurized water (or other fluid), which can be controllably provided to each of the manifolds 38 disposed along the length of the system.

The manifold 38 has a plurality of outlets 38a or openings distributed across the upper surface of the manifold 38, and accordingly along the profile of the gap 30. The outlets 38a are arranged, preferably, directly below the gap 30 and oriented upwardly, such that when pressurized water is provided to the manifold 38, the water stream will be directed upwardly from each of the outlets 38a and into contact with the underside of the belt 12 as it passes over the gap 30. The manifold 38 may include mounting flanges 38b having an elongate slot, such that the manifold 38 installation to the manifold tray 36 can be fine-tuned and adjusted to facilitate alignment of the outlets 38a with the gap 30 above. FIG. 9C illustrates the manifold 38 disposed below the gap 30.

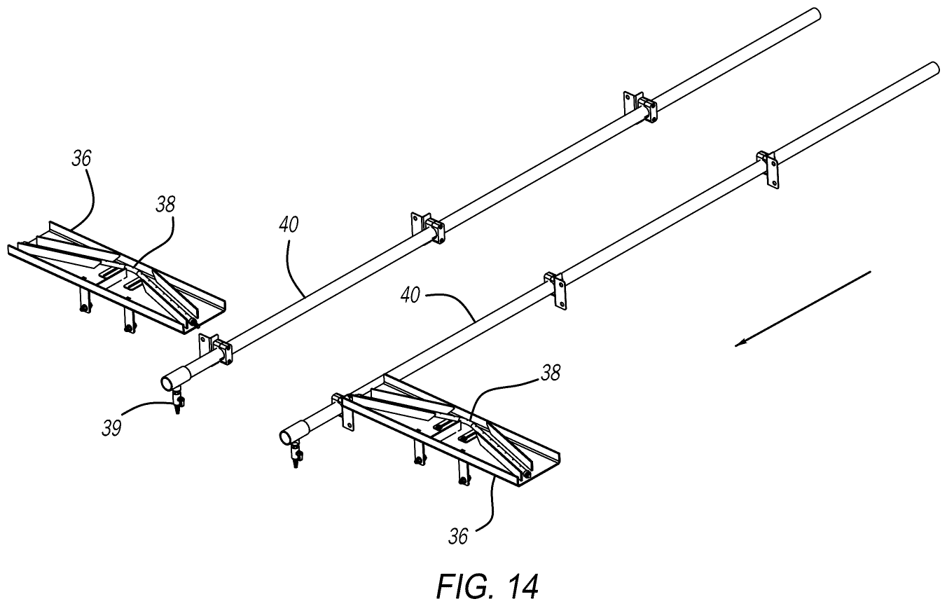

As described above, each manifold 38 may be connected to a fluid supply network, which includes the trunk lines 40, and which connects each manifold 38 to a site-specific fluid source 102, which can be reclaimed water, fresh water, or other fluid tank/reservoir. Each manifold 38 may correspond to an adjustable valve 39 (FIG. 9B and FIG. 14) to adjust the flow rate and/or pressure of water being provided, and may further include other on/off valves, check valves, or the like. The valves 39 may be manually adjustable or electronically controlled by controller 100 in communication with the valves 39.

Thus, the belt 12 can be controllably rinsed or flushed at the location of the manifold 38, and water and debris that is conveyed with the belt 12 can fall through the gaps 30 at other locations (and through the grate 32 and into the collector tray 34). In addition to the rinsing at this location of the gap 30, water and debris being rinsed can also fall back down into the manifold tray 36, similar to the collector tray 34, and over the lateral edges. Thus, again, water and dirt are blocked above the lower section of the belt at the locations of the gaps 30.

The manifold trays 38 and the grates 32 may therefore combine to provide the direct support to the plates 22, with the collector trays 34 being disposed below the grates 32 at the other locations of the gaps 30 that do not correspond to a manifold tray 38. Preferably, each gap 30 has a corresponding manifold tray 36 below the gap 30 or a collector tray 34 below the grate 32 and the gap 30, such that each of the distinct gap locations has a corresponding tray structure that will collect water and debris that falls through the gaps 30 and which may then flow out of one or more of the open sides of the tray structure. However, it will be appreciated that in some instances, a particular gap 30 may not include either the manifold tray or the collector tray, and water and debris may therefore reach the lower section of the belt 12 in these limited instances. The locations or space below the grates that are longitudinally between the collector trays 34 and manifold trays 36 may remain substantially free from any water or debris collecting structure, thereby substantially saving on expensive stainless steel material cost and associated material handling and shipping costs for the system 10. The solid nature of each plate 22 that extends between respective front end rear edges of the plate 22 allows other water and debris collection structure to be excluded along these portions of the length of the system 10 because there is no downward path for water through the solid and continuous structure of the plate 22. Depending on the length of the overall system 10, these savings can be substantial. In a preferred form, the majority of the length of the system 10 is without a water or debris collection structure.

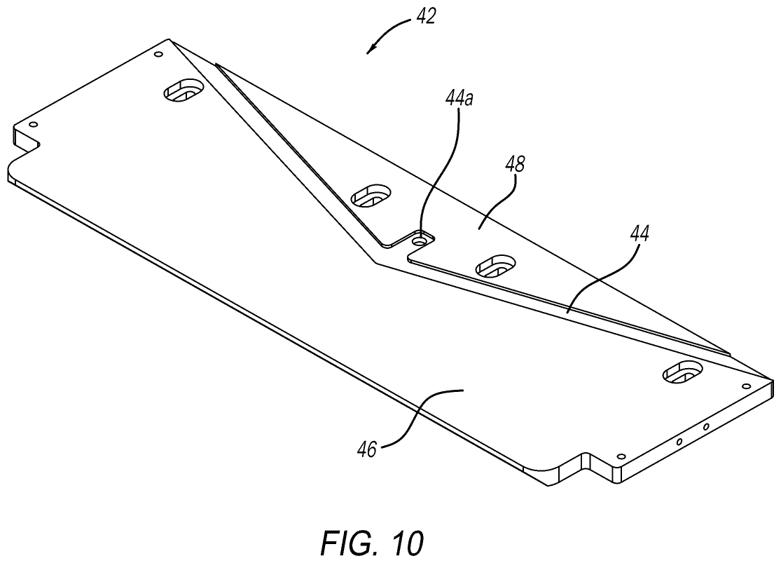

Turning now to FIGS. 4 and 10, in addition to providing water or fluid at one or more of the gaps 30, additional water or fluid may be provided via transition plates 42. The transition plates 42 are preferably provided at the entry end of the system 10 (shown in FIG. 4, with the belt/vehicle travel being provided in a direction from left to right), and positioned at the front edge of the first full-sized support plates 22 for each belt 12 (on both lateral sides at the beginning of each track). The transition plates 42 may cooperate with the support plates 22 to support the underside of the belt 12. The rear end of the transition plate 42 may support the pointed end of the adjacent support plate 22. The front end of the transition plates 42 may also provide support to partial support plates/entry plates 48a, described further below.

The transition plate includes a V-shaped recess 44 formed in the transition plate 42. The recess 44 has a V-shaped profile that corresponds to the front edge of the support plate 22, similar to the profile of the manifold 38 matching the profile of the gaps 30. The transition plate 42 further includes a front portion 46 longitudinally in front of the recess 44 and a rear portion 48 longitudinally behind the recess.

In one aspect, the rear portion 48 may be stepped down relative to the front portion 46. The adjacent support plate 22 may positioned on the rear portion 48, such that the upper surface of the support plate 22 is at the same height as the front portion 46. The front edge of the support plate 22 is positioned at the rear edge of the recess 44, such that the recess 44 is exposed and water or fluid can be provided via the recess upwardly onto the belt 12 passing above. In this aspect, the front portion 48 and the support plate 22 may support the belt 12 on the front and rear sides of the recess 44 as the belt 12 moves.

In another aspect, an entry plate 46a (similar to the support plate 22) may be provided on the front portion 46, without having the stepped surfaces. The entry plate may include a V-shaped edge that aligns with the recess 44, similar to the rear edge of the support plates. The front edge of such an entry plate 48a may be generally straight and extend laterally across the entry end. Thus, in this approach, the entry plate 46a and the following support plate 22 are disposed at the front and rear sides of the recess 44.

In one aspect, water and/or other fluid are introduced into the recess 44 via a lubrication port or inlet portion 44a formed in the transition plate 42 and in fluid communication with the recess 44. The inlet portion 44a is positioned at the apex of the V-shape of the recess 44, and receives a supply of water or fluid from the connected fluid source. The inlet portion 44a is covered by the apex of the front end of the overlying plate 22. Thus, as fluid is provided through the inlet portion 44a, the fluid will be forced into the V-shaped recess 44 and distributed across the recess 44, and upwardly into contact with the belt 12 as the belt passes over the transition plate.

The belt 12 at this early stage of the wash process can therefore be provided with lubricating fluid or the like, which lubricating fluid will be provided onto the underside of the belt 12 and then conveyed along with the belt 12 as it moves through the system 10. Additional lubrication may be provided via the manifolds 38 disposed later along the conveying path.

In one aspect, the transition plate 42 is used for lubricating the belt 12, because the belt 12 at this stage has been rinsed and is generally free from substantial debris, with the subsequent manifolds 38 being used for rinsing with water to remove the debris that is encountered as the vehicle as is washed.

Accordingly, the fluid provided at transition plate 42 may be more specifically tailored for lubrication, and the fluid provided later via the manifolds 38 may be more tailored for rinsing. It will be appreciated that various fluid types may be selected to suit the needs of the operator. In one aspect, the manifolds 38 and the transition plate 42 may be selectively connectable to more than one fluid type, which can be specifically selected depending on the type of wash selected, or other operational considerations that may change dynamically. In another aspect, the same fluid may be used at the transition plate 42 as well as the manifolds 38. The transition plate 42 may also be referred to as a lubricating plate.

In one aspect, the transition plate 42 is the first support structure encountered by the belt 12 as it is being conveyed from the entry end toward the exit end. Put another way, as the lower section of the belt 12 is being returned to the entry end, the belt 12 moves over a roller 50 at the front end, and this section becomes the upper section of the belt 12. As this section passes over the roller, it will first encounter the transition plate 42 (which may include the entry plate 46a), followed by the front edge of the first full support plate 22. This portion of the belt 12 will continue through the system, encountering successive support plates 22 and gaps 30 until it reaches the exit end of the system (FIG. 5). The roller 50 at the entry end is arranged as a passive element, such as an idler roller with various bearings, with the rotation of the roller 50 being driven by the friction from the belt 12 being pulled up over the roller 50. As further described below, the exit end of the system provides the power and mechanisms to drive the movement of the belts 12.

With reference now to the rear or exit end of the system and FIG. 5, also referred to as the drive end of the system, the system 10 includes a drive assembly 52 configured to provide the power and to engage and drive the belt 12 through the system. The drive assembly includes a drive unit 54 (which includes a motor 54a and a symmetrical gearbox 54b). The symmetrical output of the drive unit 54 is coupled to a drive shaft 56 on each lateral side of the drive unit 54, with each shaft 56 configured to engage and drive the respective belt 12 in unison. Put another way, the shafts 56 rotate together at the same speed, thereby driving the belts 12 on both sides at the same rate. In one aspect, the shafts 56 have a square cross-section, on which a plurality of sprockets 56a are indexed. The sprockets 56a are specifically arranged to match corresponding openings or divots on the underside of the belts 12. The shafts 56 are likewise indexed and coupled, such that the teeth of the sprockets 56a on each side are aligned and rotate together as driven by the symmetrical output from the drive unit 54. The drive unit 54 is preferably disposed below the belts 12 and within the envelope of the support system 16. However it will be appreciated that the drive unit 54 could be at least partially arranged outside of the support system 16 while the drive shafts 56 remain in position within the closed loops of the belts 12. The drive system may be tailored for a specific power depending on the needs of the system in a manner known in the art. For instance, a longer system conveying more vehicles may require additional power relative to a shorter system conveying fewer vehicles.

The exit end, similar to the entry end, includes a modified support plate arrangement. The vehicle is conveyed from right to left in FIG. 5 (opposite of the orientation of FIG. 4). A terminal support plate 58 is provided at the exit end, disposed adjacent and upstream from the drive shaft 56 and sprockets 56a. The terminal support plate 58 has a pointed front edge, similar to the support plates 22, but the rear edge is generally straight. The rear edge is generally parallel to the drive shaft 56, and terminates just prior to the sprockets 56a, such that the sprockets 56a extend upwardly beyond the upper surface of the terminal support plate 58 and engage the belt 12. The pointed front end of the terminal support plate 58 is received within a corresponding pointed rear angled recess of the adjacent upstream support plate 22. A corresponding gap 30 is defined as described previously.

The exit end structure, in one aspect, does not include the grate structure 32. Rather, the terminal support plate 58, being the same general material and thickness as the plates 22, is supported by an underlying exit transition plate 60. The exit transition plate 62 is similar to the transition plate 42 of the entry end in that it provides support to the overlying portion of the terminal support plate 58. Unlike the transition plate 42, the exit transition plate does not include a recess or the like for providing water or other lubricating fluid. In this area, the belt 12 is transitioned to the bottom of the system 10, and therefore the need for lubrication is reduced. However, it will be appreciated that a similar recess corresponding to the gap 30 in this area for providing rinsing or other fluid to the belt 12 could be added.

Thus, the entry end and the exit end each include a type of rolling structure. At the entry end, the passive roller 50 (idler) is provided, which routes the belt 12 up toward the conveying surface for receiving a vehicle thereon. At the exit end, the drive shaft 56 and sprockets 56a rotate to engage and actively drive and pull the belt 12, feeding the end of the upper section of belt 12 down below the conveying surface, becoming the lower section of the belt 12, for return to the entry end.

At both the entry end and the exit end, in the direction of vehicle travel, before the entry end roller 50 and after the exit end sprockets 56a, respectively, the system includes floor plates 64. The floor plates 64 are generally rectangular, and provide a flat surface adjacent the rolling components to extend the overall upper surface of the system, allowing the vehicles to enter and exit the belt surface from and to the surrounding area. The vehicle will pass over the upstream floor plates 64 at the entry end and then over the idler roller 50 and onto the belt 12. As the vehicle exits the belt 12 and passes over the sprockets 56a, the vehicle will pass over the downstream floor plates 64.

The belts 12 have been described both together and individually in the above description. In one aspect, the belt 12 on one lateral side of the system 10 may differ from the belt 12 on the other lateral side of the system. More particularly, shown in FIG. 1, one of the belts 12 (the left-side belt in the Figures) may be in the form of belt 12a and may include a plurality of laterally aligned sets of tabs 12b extending outwardly from the outer surface of the belt 12a. The tabs 12b are longitudinally spaced along the surface of the belt 12a, at a longitudinal distance sufficient to accommodate a vehicle wheel longitudinally between the sets of tabs 12b. The tabs 12b, at each longitudinal location, may be distributed across the width of the belt 12a, with space or openings provided between the laterally distributed sets of tabs 12b. The tabs 12b are arranged low enough to allow a vehicle to drive over the upstanding tab, such that the driver will typically feel the impact of the tab 12b on the vehicle tire and also when the tire has been received longitudinally between adjacent sets of tabs 12b. The tabs 12b assist in creating an initial engagement between the vehicle and the belt 12, and assist the belt 12 in conveying the vehicle through the treatment area. The tabs 12b may be included on only a single side of the system, because both belts 12 are conveyed together at the same rate by the symmetrical drive unit 54.

In view of the projecting tabs 12b on one side of the system, the floor plates 64 on the corresponding lateral side may include one or more open notches 64a, which allow the tabs 12b to pass through the notches 64a as the belt 12 transitions from the upper section to the lower section at the exit end and back up to the upper section at the entry end. The lateral side of the system without the tabs may have a generally flat edge with no notch at the interface between the floor plate 64 and the sprockets 56a or roller 50.

The above-described components of the support system 16, such as the various plates, trays, grates, etc. are each configured to be fixed and retained in the support system 16. With reference to FIGS. 2 and 3, the support system 16 accordingly includes a rigid and robust frame structure 70. The frame structure 70 is sized and arranged to be rigidly mounted within the trench 18, providing an underlying support for the various other components described above that more directly interact with the belts 12 being conveyed through the system 10. The frame structure 70 may be provided in sections in a generally modular fashion depending on the overall length of the system to be installed. For instance, both ten foot sections and five foot sections may be provided, as described further below.

The frame structure 70, at least in portions, includes galvanized steel. The galvanized steel provides the strength of steel and corrosion resistance of stainless steel, but without the high cost of stainless steel. Due to the substantial size requirements necessary for supporting the vehicles being conveyed through the system, the use of galvanized steel rather than stainless steel provides a substantial cost savings.

To install an underlying frame structure in a flat top conveyor, it is preferred to weld the structure in place to the concrete floor and trench. To overcome difficulties encountered when welding with galvanized steel, the frame structure 70 of the present disclosure includes tailored cover portions or leg portions that may be selectively bolted to the galvanized steel. These cover portions are stainless steel, such that welding may performed directly on the cover portions. Thus, a substantial part of the support system and frame structure may be galvanized, providing cost savings, while also permitted the preferred welding attachment process to be performed on the more limited amount of non-galvanized portions.

The support system 16 is preferably attached directly to the floor of the trench 18, rather than to the sidewalls of the trench 18. Such an installation is better suited to handle to the downward loads endured by the system due to the weight of the system and the vehicles, relative to systems that are bolted into the sidewalls of the trench. Moreover, by attaching to the floor of the trench 18, lateral support beams spanning across the trench 18 can be excluded, thereby providing better access to the system for maintenance and repair when necessary. Put another way, the middle section of the system 10 can be opened and walked through from front to back along the length of the system 10 by removing the central grates that span between the frame structure 70 on each lateral side.

The frame structure 70 is generally symmetrical on each lateral side of the system 10. Accordingly, one side of the frame structure 70 will be described. Put another way, the frame structure 70 below one of the belt tracks will be described.

The frame structure 70 includes a galvanized upper portion 72 including a plurality of interconnected beams. The beams include longitudinally extending side supports 72a on each lateral side of the upper portion 72. The side supports 72a are arranged to support the sides of the grate structures 32 that are placed onto the upper portion 72. The side supports 72a also support the manifold tray 36. In addition to the side supports 72a, a central support 72b extends generally along the center line. The upper portion 72 further includes a plurality of laterally extending beams 72c that are below the side supports 72a and central support 72b and provide support thereto.

The beams 72c may each define slots into which the side and central supports 72a, 7b may be placed. The side and central supports 72a, 72b may have an L-shaped cross-section, with one portion being disposed generally vertically into the slot of the beams 72c, and the other portion extend horizontally to provide the support surface for the overlaying structure.

The beams 72c may be disposed at longitudinal spacing corresponding to the lengths of the plates 22, such that the beams 72c may provide the mounting surface for the collector trays 34 below the grates. The manifold trays 38 may also be mounted to the beam 72c, such as at one end of the upper structure 72. Each modular section of the frame structure 70 (such as the 10 foot or 5 foot sections) may be arranged such that the support plates will overhang one end, to be received and supported by the next modular section. The beams described herein are part of the galvanized portion and make up a substantial portion of the frame structure 70.

Additionally, the beams 72c may further provide the mounting structure for leg portions 74. Leg portions 74 may be separate pieces relative to the upper portion 72. The upper portion 72 is preferably connected and welded prior to the galvanizing step, and may be shipped as a generally flat unit to-and-from the galvanizing processing location. Additionally, the upper portion 72, once galvanized, may be delivered as a flat unit, with the leg portions 74 being later attached at the installation site. Accordingly, the flat arrangement of the upper portions 72 allows an increased number of units to be shipped within a given shipping envelope, further reducing overall cost. The upper portion 72 may therefore also be referred to as a galvanized upper portion 72.

The leg portions 74 may be stainless steel, and may be bolted to the galvanized upper portion 72. Other sections of the leg portions 74 may therefore be welded directly to other corresponding floor support portions 74a, which are themselves secured to the floor of the trench 18. The floor support portions 74a may be stainless steel, carbon steel, or other steel structure capable of being fixed to the bottom of the trench, and to which the leg portions 74 may be welded. The floor support portions 74a match the leg portions 74 such that the leg portions may slide relative to the floor support portions 74a during installation to achieve the desired height of the system as the components are installed to account for tolerances and variations in the trench structure.

Thus, to install the frame structure 70, the galvanized structures may be provided separately and do not need to be welded. The portions of the structure that need to be welded may be stainless steel and may be bolted or otherwise non-welding attached, so that welding can be limited only to the reduced amount of stainless steel structure. Thus, on site welding may still be used, while less expensive galvanized support structure for the majority of the support system.

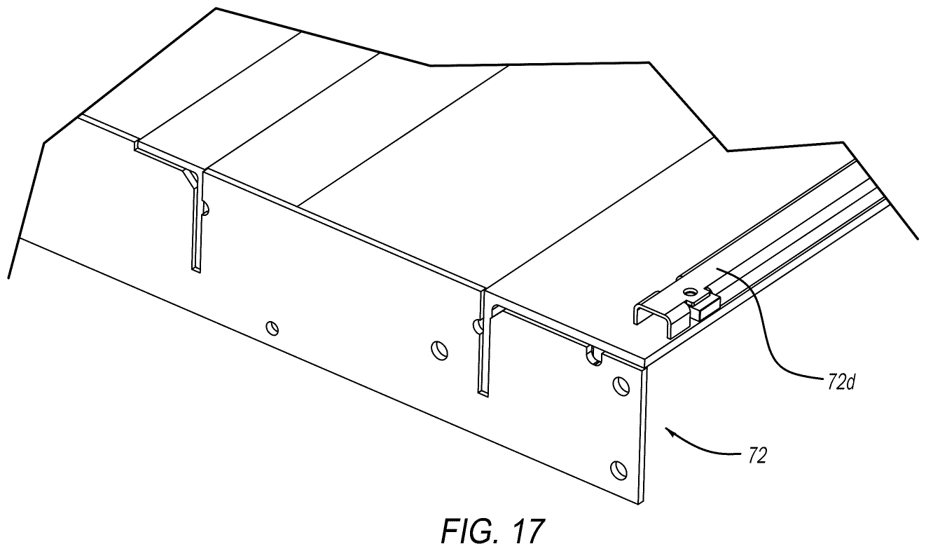

With reference back to the upper portion 72, the side supports 72a include mounting holes for wall sections 72d. The wall sections 72d extend longitudinally and are installed on each lateral side of the upper portion 72 to the top surface of the side supports (see FIG. 17), and provide lateral support on each side of the grate structures 32 that are likewise placed on the top of side supports 72a. The wall sections 72d are slightly shorter than the length of the grate structure 32, and therefore create a lateral opening 72e longitudinally between adjacent wall sections, thereby allowing water to flow outwardly and drain from the top surface of the side supports 72a.

The wall sections 72d include mounting holes for the keyed clamps 23 described previously that hold down the plates 22. The clamps 23 are disposed on each lateral side of the support plates 22. The clamps 23 include teeth 23a, projecting downwardly that are received in the corresponding notches of the upper support plates 22, which accordingly hold the plates 22 in place longitudinally to maintain the gap 30. The clamps 23 provide lateral support to the belt 12. Preferably, the upper surface of the clamps 23 corresponds to the upper surface of the belt 12. The clamps 23 are also installed such that an opening 23b is provided between longitudinally adjacent rails, allowing water to pass laterally outward through the openings.

The clamps 23 may have a length that is similar to the length of the wall sections 72d. Thus, the wall sections 72d attached to the side supports 72a and the clamps 23 attach to the wall sections 72d. The grates 32 are between the wall sections, and the plates 22 and belt 12 are between the clamps 23.

Thus, with the grates 32 installed on the upper portion 72, and the clamps 23 mounted on the upper portion 72 and engaging the upper support plates 22, the plates 22 are supported by the grates 32 and held in place by the clamps 23, and their position is maintained as the belt 12 travels over the plates 22.

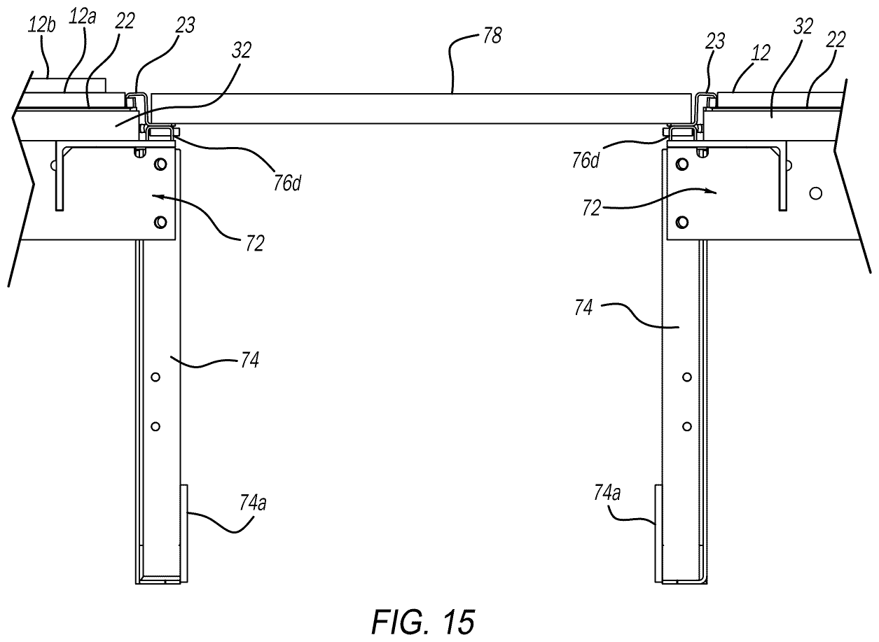

When the upper portions 72 of the frame structure are disposed on each lateral side, the laterally inner clamps 23 and the laterally inner walls sections 72d also function to hold in place a central floor grate 78. The central floor grate 78 is similar to the grate structures under the plates 22. The laterally outer edges of the central floor grate 78 are supported below by the portion of the clamps 23 disposed on top of the wall sections 72d. The upper surface of the central floor grate 78 is preferably at the same height as the top of the clamps 23, and also the belts 12 disposed on the plates 22, thereby providing a generally continuous flat surface across the upper surface of the system 10. These central floor grates 78 can be easily removed to provide access to the lower areas of the system 10 (in the trench 18) for maintenance and the like. FIG. 15 also illustrates the lateral positioning and support for the grates 32 and 78.

The frame structure 70 also includes an entry section 71 and an exit section 73, shown in FIGS. 4 and 5, respectively, similar to the upper portion 72. The entry and exit sections 71, 73 are in the form of interconnected support beams that are welded together as a unit and then galvanized. The leg portions of these sections 71, 73 are also welded with the other support beams, unlike the stainless steel legs 74 that bolt to the upper portion 72. The entry and exit sections 71, 73 each include cover plate mounting sections 71a or 73a, onto which corresponding stainless steel cover plates 71b, 73b (or other weldable stainless steel structure) may be bolted. The cover plates 71b, 73b can therefore be directly welded to corresponding stainless steel structure attached to the bottom of the trench, thereby reliably securing the entry and exit section 71 and 73 in the system.

The exit section 73, having the drive unit 54 and associated structure, in one approach, is installed first. Then, the upper portions 72 and leg portions 74 are secured, working from the exit section 71 toward the entry section 73 to secure the frame structure 70 in the trench 18. In another approach, the entry section 73 is installed first, and the exit section 73 is installed last. Thus, it may be preferable to install the various sections in longitudinal order, beginning from one of the end sections.

The above description has related to the portions of the support system 16 that are generally used for supporting the upper section of the belts 12 as the belts 12 travel through the system. However, the system also provides support to the lower returning section of the belt.

With further reference to the lower sections of the system 10, the system further includes multiple assemblies of return rollers 80 that provide support below the lower section of the belt 12, thereby supporting the belt 12 as the belt 12 travels back to the entry end of the system.

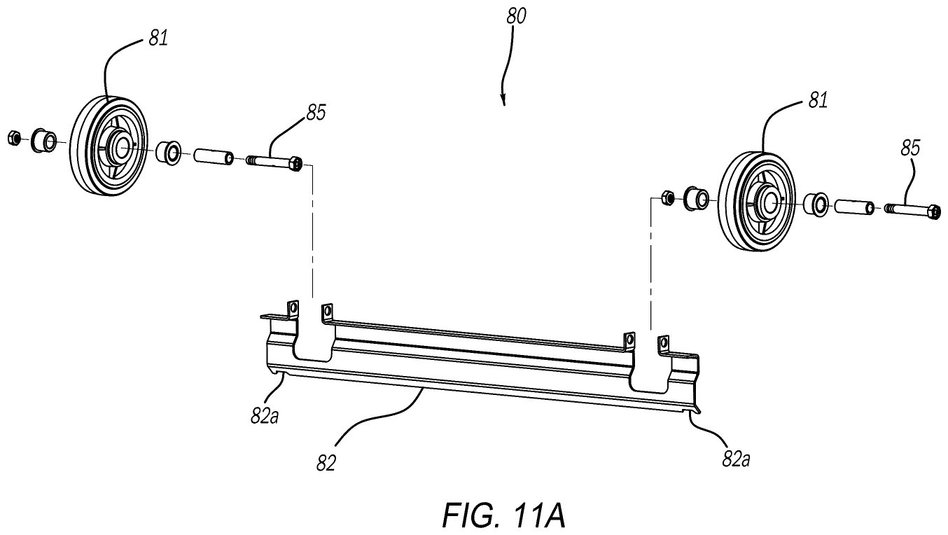

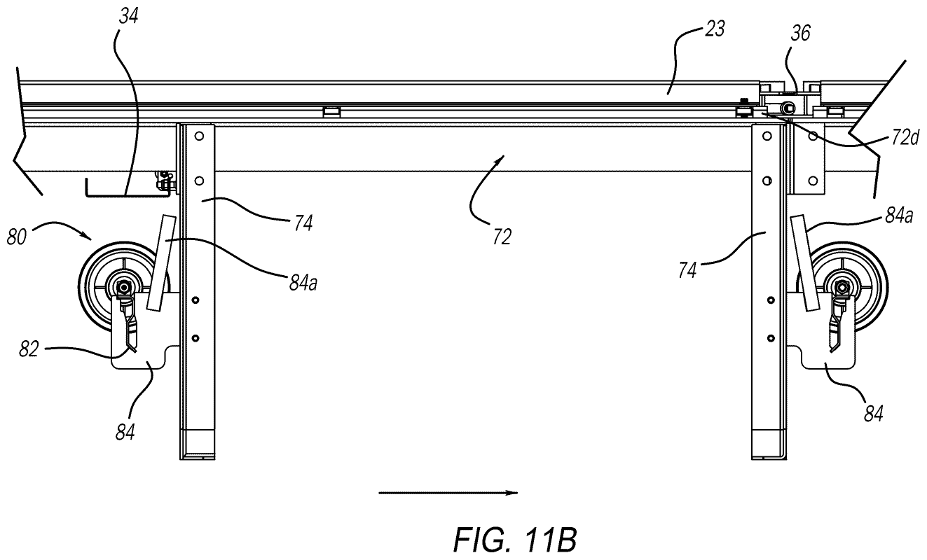

As shown in FIGS. 11A and 11B, return rollers 80 include a soft tread or wheel 81 attached to a roller plate 82 that is in the form of a bent sheet of stainless steel. The wheels 81 may be supported on lubricated bolts 85 or other bearing structure providing good rolling performance. The roller plate 82 has a bent cross-sectional contour configured to fit with a corresponding contoured slot 84b of lateral side guides 84. The lateral side guides 84 are in the form of plates fixedly mounted to leg portions 74 on each lateral side of each frame structure 70. The roller plate 82 includes notches 82a in a lower edge sized to correspond to the lateral spacing of the side guides 84. The bent cross-section of the roller plate 82 provides rigidity in the fore-and-aft direction and support for the rollers 80, with the notches 82a providing a lateral fixing mechanism relative to the side guides 84. The return rollers 80 and plate 82 can therefore be easily attached and held in the side guides 84 without the use of mechanical fasteners or the like. This facilitates easy removal, replacement, and maintenance of the return rollers as necessary, without the need for specific tools or manipulation of mechanical fasteners in a generally restricted area where maintenance can typically be difficult. Thus, the return rollers 80 are securely held in place relative to the frame structure 70 and functional to withstand the weight of the belt 12 as the belt 12 is conveyed back to the entry end of the system.

The side guides 84 may further include a post 84a extending upwardly, which provides a lateral guide structure on each side of the lower return section of the belt 12 as it travels toward the entry end. However, the lateral guiding and control of the position of the belt 12 on the upper portion already typically keeps the lower section of the belt 12 centered, such that the belt 12 may not come into contact with the posts 84a as it travels toward the entry end.

The return rollers 80 can be distributed at various locations along the length of the system, and shown in various other Figures through the present disclosure. Preferably, sets of the rollers 80 are distributed at a non-uniform longitudinal spacing to reduce instances of harmonic vibrations. These harmonic vibrations could otherwise result from the lower section due to the lower section being generally slack or loose as it is returned to the entry end. The weight of the belt 12 itself provides sufficient tension at the entry end of the system on the belt 12 to keep the belt 12 sufficiently flat between the driven exit end and the passive entry end. In the event the belt 12 is pushed at the upper section at a rate exceeding the driven rate, the belt 12 may bunch up briefly and slightly, with the belt 12 being pulled forward to take up this upper slack. In one aspect, the longitudinal spacing of the rollers 80 on the left side is the same as on the right side of the system. However, the spacing on either side could also be different.

It will be appreciated that the illustrated spacing of the rollers 80, and the length of the system overall, is one example. Various other overall lengths may accordingly result in an increase or decrease in the number of rollers 80 used, which may be spaced at different spacing relative to each other.

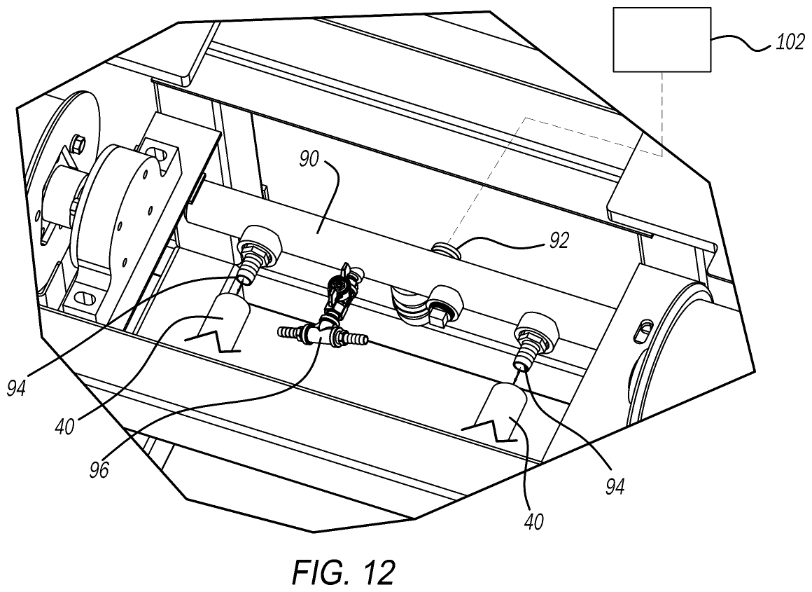

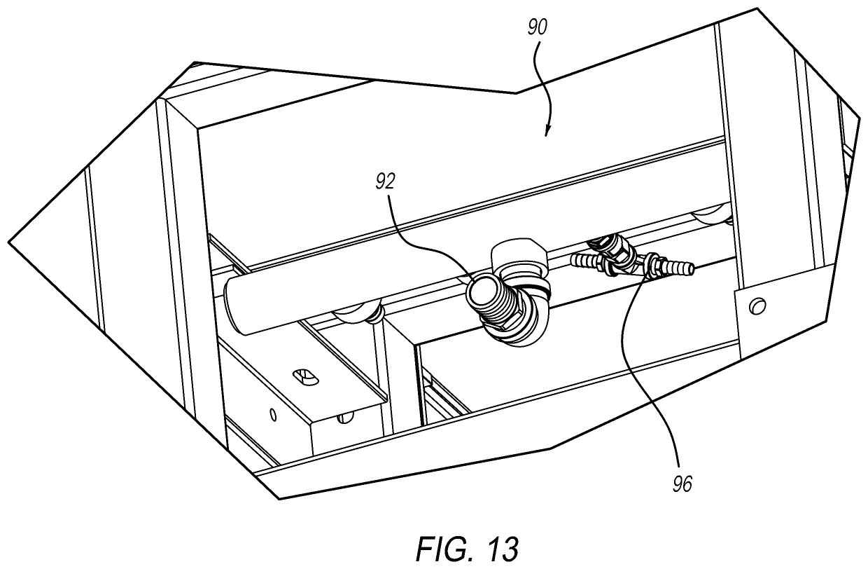

With reference to FIGS. 12 and 13, as described above, various rinsing and/or lubricating fluid may be provided to the belt 12 and associated components. In one aspect, the fluid may be provided by a main fluid manifold 90, which may be centrally located and mounted at the entry section 71. Water or fluid can be provided via hose or tube connected to the water source. The manifold 90 may receive the supply of fluid at inlet 92. The manifold may include a pair of side outlets 94, which connect to the previously described manifolds 38. A central outlet 96 is attached to splitter, which connects to the inlet portion 44a of the transition plates. It will be appreciated that other controlled fluid provision may also be used along with the above described manifolds and fluid outlets of the system.

With reference to FIG. 14, trunk line 40 may attach to each of the side outlets 94 (FIG. 12) and extend along each side of the system for connecting to the manifolds 38. The trunk line may include valves 39 (which may be a manually controlled valve or which may be electronically controlled according to a control system) associated with each of the manifolds 38 for controlling the fluid provided to each of the manifolds 38. The trunk lines may be attached to the frame structures 70 via brackets or the like.

With reference back to FIGS. 2 and 3, the system 10 may further include side grating 78a, similar in style and construction to the central grating 78. The side grating 78a, like the central grating 78, is adjacent the upper surface defined by the belts 12 and the upper surface of the clamps 23, thereby extending the generally consistent upper surface of the system 10, extending along the edges of the trench 18 to provide a consistent surface along which to walk or for vehicles to maneuver. The side grating 78a may be supported by the flat portion of the clamp 23 that is attached to the tops of the laterally outward wall portions 72d on each lateral side of the system, similar to the support of the central portion.

As described above, the system 10 may include the provision of various lubricating and/or rinsing fluids provided to various locations. The rinsing manifolds 38 on each side may each be connected to corresponding supply lines or trunk lines 40 on each side, with individual valve-based control. As described above, the valve-based control may be manually adjusted, or may be electrically adjusted in response to control signals from a controller and control unit with software and control instructions. The other manifolds and fluid supply components described herein may also include controllable valves. Accordingly, the system 10 may utilize a smart control system to conserve water or fluid use in an efficient manner. For instance, depending on the position of the vehicle in the system or the number of vehicles in the system, the rinsing manifolds 38 may be controlled to be activated at certain times where rinsing is desired, and deactivated if a vehicles are not passing over a given area at a given time. In some cases, such as with reclaimed water or the re-use of water, the manifolds 38 may be left active for a greater amount of time, relative to non-reusable water sources. The specific control of the various fluid provision components of the system may therefore be controlled and provided on demand and for various purposes, as desired.

With reference to FIG. 1, when fully assembled, the belts 12 on each side of the system cover the tops of the support plates 22 and the sprockets 56 or idler rollers 50. Thus, the underlying grating 32 on each side is also covered, as are the manifolds 38. The clamps 23 are secured to the wall portions 72d and pinch down on the support plates 22 via the downwardly extending teeth 23a of the clamps 23 (seen in FIG. 3), which are received in the slots 22a of the plates 22 to secure and maintain the position of the plates 22 on top of the grates 32. FIG. 15 illustrates a front cross-sectional view where the component stackup can be seen.

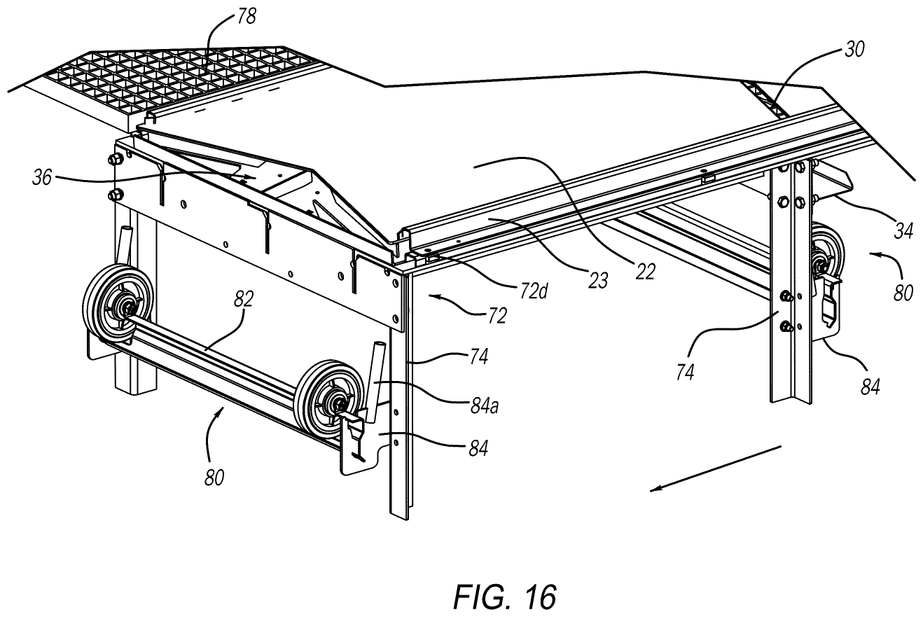

In some instances, for maintenance or observation, it may be desirable to gain access to the plates 22, grates 32, etc. In such cases, the belt 12 may be temporarily removed from at least a portion of the system to uncover the underlying components. To remove the belt 12 from a portion of the system, the central grating 78 may be removed to provide increased access to the system. The portion of the belt 12 intended to remain may be securely clamped to the frame structure, leaving the belt 12 secure din place. An upstream portion of the belt is then pulled via a winch, ratchet, or the like, creating a bulge in the upper section of the belt 12 upstream from the clamped location. The slack in the lower section of the belt allows for such bunching. The belt 12 is then secured and clamped at a location upstream of the bulge. In this state, the links of the belt 12 may be disconnected at a location longitudinally between the clamed locations. The belt 12 is then split and can be folded over the clamped locations, revealing the underlying structure. FIG. 16 illustrates a closer perspective view of a section of the system with belt removed, and further illustrating the clamps 23 attached to the wall sections 72d and clamping the plates 22 down onto the grates 32, which are supported on the upper portion 72.

To remove a support plate from above the grates 32, the clamps 23 may be disassembled from the wall portion 72 on each side of the plate 22. FIG. 17 illustrates a section of the system with the clamps 23, plates 22, and grates 32 removed, illustrating the wall portion 72d attached to the upper portion 72. In some cases, two clamps 23 may need to be removed on each side, if the support plate spans between two clamps 23. With the clamps 23, the support plate 22 can be lifted out of the system, revealing the underlying grate 32 and/or manifold 38. The manifold or grate 32 may then be lifted out of the system if necessary. The manifold 38 is secured to the frame structure 70 via fasteners, but the grate 32 be in place without fasteners and can be lifted out without the use of tools. To re-attach the components, the manifold 38 may be re-secured and/or the grate 32 may be placed back into the space between the wall portions 72d. The support plates 22 may be placed back onto the grates 32 and/or manifold 38.

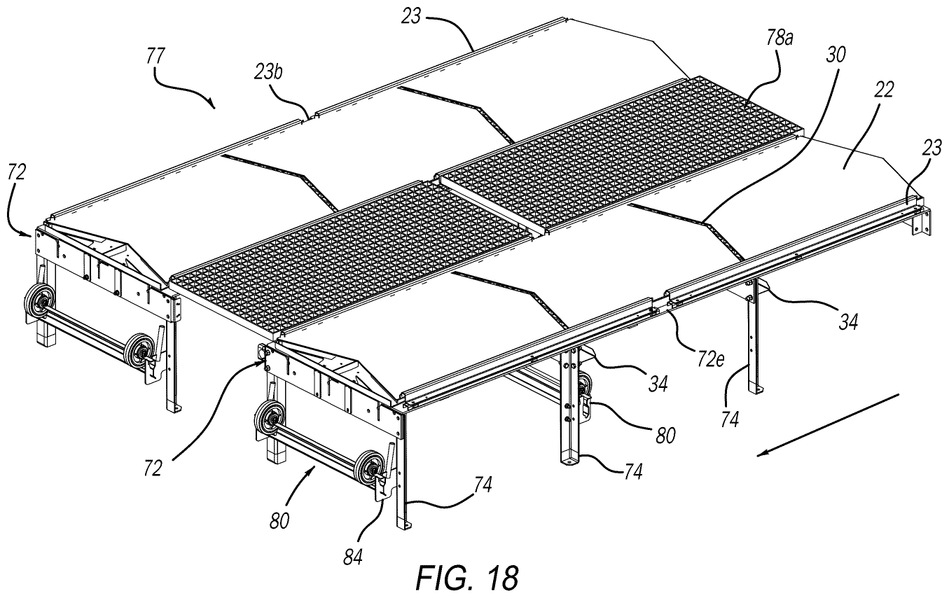

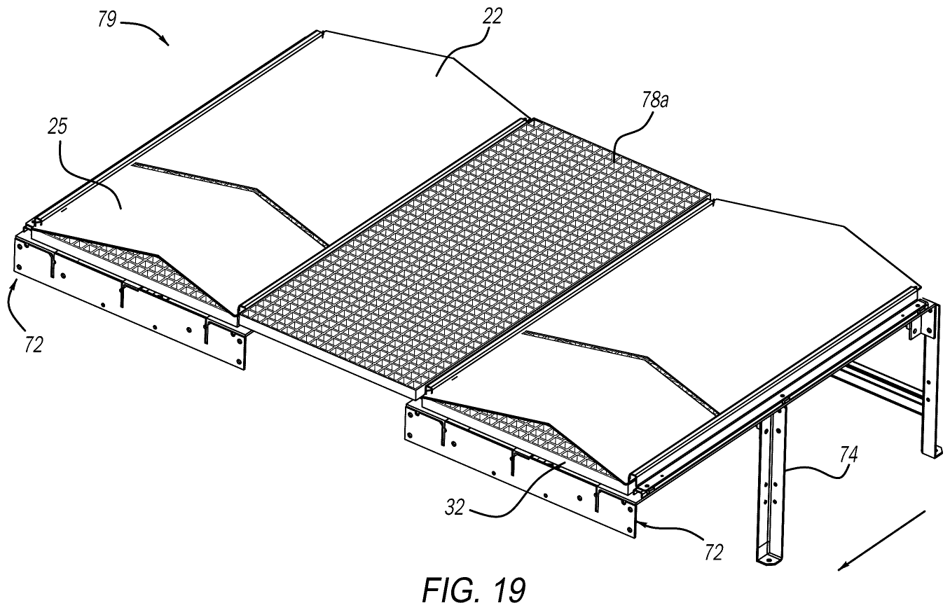

With reference again to FIG. 18-19, the clamps 23, having downwardly projecting teeth 23a, will accurately locate the plates 22 via the corresponding notches 22a (see FIG. 3). The clamps 23 are screwed or bolted onto the wall portions 72d at predetermined locations. The wall portions 72d are likewise secured to the frame structures 70 at predetermined locations. As described above, the wall portions 72d may be secured to the frame portions 70 are predetermined locations such that longitudinally adjacent wall portions 72d will be spaced apart, defining a passageway or opening 72e between them. This opening allows water or debris traveling with the belt 12 to exit to the sides through these openings. Unlike the gaps 30, the water exiting the belt in this location does not exit above the return portion of the belt 12, and accordingly no tray is provided at these locations. However, if desired, a similar collector tray could be added under the opening between the wall portions 72d. Similar to the wall portions 72d, the clamps 23 also define an opening 23b longitudinally between them. The openings 72e and 23e may be at the same longitudinal location along the system.

The clamps 23 preferably longitudinally span more than one plate 22 (as seen in FIGS. 18 and 19), such that the spacing of the gap 30 between adjacent plates 22 is controllably set. In one aspect, one clamp generally secures one-and-one-half plates 22, such that two clamps 23 on each lateral side of the plates 22 secure three plates 22 in the ten foot section 77. In the five foot section 79, as shown, a reduced-size plate 25 may be combined with one standard length plate 22. It will be appreciated that other lengths of frame sections may have additional plates or different plate lengths.

The illustrated system 10, shown in FIG. 1, includes a ten foot section 77 and a five foot section 79 of the frame structure 70 disposed between the entry section 71 and the exit section 73. The ten foot section 77 and five foot section are also shown in FIGS. 18 and 19. It will be appreciated that in various other arrangements, additional sections may be provided. Other fixed length sections are also contemplated to suit different installation sites. Generally, to maintain consistent gap spacing, a predetermined and constant length plate 22 may be provided for use in the ten foot section 77, such that three plates 22 span the length of each frame structure 72. The manifolds 38 may be provided at the downstream ends of each ten foot section 77, which will accordingly be partially disposed over the upstream end of the next frame structure section (which may another ten foot section 77 or which may be the five foot section 79). Generally, the last section in the chain of sections is the shorter section when such arrangements are provided. In one aspect, the final section, such as the illustrated five foot section 79 of the illustrated embodiment, does not include a manifold at the downstream end, with the grating extending to the end of the section, because the belt 12 is approaching the exit end and the sprockets 56. The portion of the grate 32 at the end of the five foot section 79 is exposed in FIG. 15, but when assembled, the pointed end of plate 58 of the exit section 73 will overlay this portion of the grate 32 and be supported by the grate 32.

The above description includes various aspects of the disclosure that may be used alone or in combination. It will be appreciated that the disclosure accordingly is also directed to such combinations, whether or not such combinations are explicitly disclosed. It will be further appreciated that the illustrated and described embodiments, while including various combinations of the disclosed aspects of the disclosure, do not necessarily require each illustrated and described aspect.

What is claimed is:

1. A vehicle treatment system comprising:
a continuous conveyor belt having an upper section and a lower section when installed as a closed loop in the system, wherein the belt is configured to be conveyed through the system such that the upper section conveys a vehicle from an entry end to an exit end of the system;
a support system configured to support the conveyor belt, wherein the support system includes:
a plurality of support structures in the form of a support plate, wherein the support plate directly contacts and supports the underside of the upper section as it is conveyed from the entry end to the exit end;
at least one grate structure disposed below the support plates, wherein the grate structure defines a plurality of open cells extending therethrough, wherein the grate structure supports the underside of the support plates;
a frame structure disposed below the grate structure, wherein the frame structure supports the underside of the grate structure;
wherein the support plates are positioned on the grate structure to define a plurality of gaps longitudinally between adjacent ones of support plates, such that water and dirt will pass through the gap and the grate structure during a vehicle wash process;
wherein a collector tray is disposed below multiple ones of the gaps defined between adjacent support plates such that multiple collector trays are disposed along the length of the system.

2. The system of claim 1, wherein the support plates do not have any channels or apertures formed therethrough.

3. The system of claim 1, wherein each support plate is completely solid between a front edge and rear edge of the support plate along an interface between the support plate and the belt.

4. The system of claim 1, wherein the supports plates have a chevron shape with a V-shaped front edge and V-shaped rear recess, wherein the support plates are disposed in series longitudinally and define V-shaped gaps therebetween.

5. The system of claim 1, wherein the collector trays have a wall portion formed at forward and rear sides of the tray, and the laterally inner and outer sides are open.

6. The system of claim 5, wherein the collector trays are spaced apart along the length of the belt, wherein the collector trays are disposed below the grate structure and above the lower section of the belt.

7. The system of claim 1, wherein a rinsing mechanism is disposed below one or more of the gaps defined between adjacent support plates and aligned with the gap, such that an upward rinsing spray passes upwardly through the corresponding gap and into contact with the underside of the upper section of the belt as the belt is conveyed over the gap.

8. The system of claim 7, wherein the rinsing mechanism includes a rinse manifold disposed within a manifold tray.

9. The system of claim 8, wherein the manifold tray is disposed in a gap defined longitudinally between successive grate structures.

10. The system of claim 8, wherein the manifold tray includes a plurality of wall members extending upwardly from a base of the manifold tray, wherein the wall members support the underside of one or more of the support plates.

11. The system of claim 5, wherein a rinsing device is positioned laterally adjacent the collector tray and controllable to provide a rinsing spray to the collector tray.

12. The system of claim 1, wherein a lubricating device is positioned at an entry end of the system, wherein the lubricating device is a plate having a fluid inlet disposed therein, wherein the fluid inlet is in fluid communication with a recess formed in the plate, wherein the recess matches a profile of a front edge of the support plate disposed adjacent the recess, such that fluid provided from the inlet enters the recess and exits the recess upwardly at the front edge of the support plate and onto the underside of the belt, wherein the belt carries the fluid onto the support plate.

13. The system of claim 12, wherein the fluid inlet is covered by the front end of the support plate, such that fluid from the inlet is blocked by the front end and forced into the recess.

14. The system of claim 1, wherein the support system includes support rollers disposed below the lower section of the belt and supporting the underside of the lower section of the belt as the belt travels from the exit end to the entry end.

15. The system of claim 14, wherein the support rollers are provided on a roller frame, wherein the roller frame has a shape that is received and fixed in a corresponding slot structure without the use of fasteners.

16. The system of claim 15, wherein the support rollers are spaced apart longitudinally at non-uniform locations along the length of the belt to reduce harmonic undulations of the lower section of the belt.

17. The system of claim 1, wherein a drive system is disposed at the exit end of the system, wherein the drive system includes an output shaft having a plurality of sprockets indexed to links of the belt, such that each side of the system is driven in unison.

18. The system of claim 17, wherein one of the belts includes a plurality of projecting tabs that project upwardly from the upper section and engage with one or more vehicle wheels.

19. A vehicle treatment system comprising:
a continuous conveyor belt having an upper section and a lower section when installed as a closed loop in the system, wherein the belt is configured to be conveyed through the system such that the upper section conveys a vehicle from an entry end to an exit end of the system;
a support system configured to support the conveyor belt, wherein the support system includes:
a plurality of support structures in the form of a support plate, wherein the support plate directly contacts and supports the underside of the upper section as it is conveyed from the entry end to the exit end;
at least one grate structure disposed below the support plates, wherein the grate structure defines a plurality of open cells extending therethrough, wherein the grate structure supports the underside of the support plates;
a frame structure disposed below the grate structure, wherein the frame structure supports the underside of the grate structure;
wherein the support plates are positioned on the grate structure to define a plurality of gaps longitudinally between adjacent ones of support plates, such that water and dirt will pass through the gap and the grate structure during a vehicle wash process,
wherein the support plates include a plurality of notches formed at lateral edges of the support plates, wherein a side clamp is fixed to the frame structure and includes downwardly projecting teeth, wherein the teeth extend into the notches, wherein the side clamp fixes the support plate longitudinally via the teeth projecting into the notches.

20. The system of claim 19, wherein the side clamp engages multiple adjacent support plates, such that the gap defined between adjacent support plates is fixed and maintained via predetermined spacing of the teeth and the notches.

21. The system of claim 19, wherein the support system includes an upper frame on each lateral side of the system, wherein each upper frame includes a plurality of welded beams, wherein the grate structures are disposed on the upper frame and supported on the upper frame.

22. The system of claim 21, wherein the upper frame is galvanized steel, wherein the support system includes a plurality of separate leg portions mounted to the upper frame, wherein the leg portions are stainless steel and attached to the galvanized steel upper frame via fasteners, wherein the stainless steel leg portions are welded to floor supports that are fixed to a bottom of the vehicle treatment area.

23. The system of claim 21, wherein the upper frame has a rectangular envelope not including the leg portions, wherein the rectangular envelope has a height less than a lateral width of the upper frame, such that the upper frame are stackable and shippable in a welded state before and after galvanizing.

24. The system of claim 21, wherein each upper frame includes wall portions disposed on opposite lateral sides of an upper surface of the upper frame, wherein the grate structure is disposed laterally between the wall portions.

25. The system of claim 24, wherein each upper frame includes multiple wall portions disposed on each lateral side, wherein longitudinally adjacent wall portions are spaced apart to define a longitudinal opening therebetween such that water may pass laterally outward between the wall portions through the longitudinal opening.

26. The system of claim 24, wherein the side clamps are disposed on the upper surface of the wall portions, wherein the side clamps are disposed over the support plates that are disposed on the grates and clamp the support plates in place, wherein the side clamps further have a recessed surface relative to a top surface of the side clamp, the recessed surface configured to support a further grate.

27. The system of claim 26, wherein the side clamps include laterally inner side clamps on the laterally inner sides of each of the upper frames and laterally outer clamps on the laterally outer sides of the upper frames, wherein the further grate is a center grate disposed laterally between the laterally inner side clamps or the further grate is a side grate disposed laterally outward from the laterally outer side clamps.

28. The system of claim 21, wherein the support system further includes entry and exit sections, wherein the exit section supports a drive unit and drive shaft that drives the belt, and the entry section supports an idler roller and a lubricating device that lubricates the belt.

29. The system of claim 19, wherein the support system includes support rollers disposed below the lower section of the belt and supporting the underside of the lower section of the belt as the belt travels from the exit end to the entry end, wherein the support rollers are provided on a roller frame, wherein the roller frame has a shape that is received and fixed without the use of fasteners in a slot structure formed in the frame structure.
